(19) United States
(12) Patent Application Publication
(10) Pub. No.: US 2024/0349259 A1
(43) Pub. Date: Oct. 17, 2024

(54) SYSTEMS AND METHODS FOR WIRELESS SIDELINK COMMUNICATIONS

(71) Applicant: Meta Platforms Technologies, LLC, Menlo Park, CA (US)

(72) Inventors: Yi Lu, Kirkland, WA (US); Qi Qu, Redmond, WA (US); Ping Wang, Redmond, WA (US); Qing Zhao, Fremont, CA (US)

(73) Assignee: Meta Platforms Technologies, LLC, Menlo Park, CA (US)

(21) Appl. No.: 18/440,630

(22) Filed: Feb. 13, 2024

Related U.S. Application Data
(60) Provisional application No. 63/459,011, filed on Apr. 13, 2023.

(51) Int. Cl. H04W 72/0446; H04W 72/25

(52) U.S. Cl. CPC H04W 72/0446; H04W 72/25

(57) ABSTRACT

Systems and methods for wireless sidelink communications may include a first wireless communication device which establishes a sidelink (SL) session with a second wireless communication device. The first wireless communication device may reserve a block of SL slots for transmission of traffic between the first wireless communication device and the second wireless communication device. The first wireless communication device may transmit, to the second wireless communication device, the traffic of the SL session in the block of SL slots.

### CROSS-REFERENCE TO RELATED APPLICATIONS

This application claims the benefit of and priority to U.S. Provisional Application No. 63/459,011, filed Apr. 13, 2023, the contents of which are incorporated herein by reference in their entirety.

### FIELD OF DISCLOSURE

The present disclosure is generally related to wireless communication between devices, including but not limited to, systems and methods for wireless sidelink communications.

### BACKGROUND

Augmented reality (AR), virtual reality (VR), and mixed reality (MR) are becoming more prevalent, which such technology being supported across a wider variety of platforms and device. Some AR/VR/MR devices may communicate with other devices within an environment via respective sidelink communication channels.

### SUMMARY

In one aspect, this disclosure is directed to a method. The method may include establishing, by a first wireless communication device, a sidelink (SL) session with a second wireless communication device. The method may include reserving, by the first wireless communication device, a block of SL slots for transmission of traffic between the first wireless communication device and the second wireless communication device. The method may include transmitting, by the first wireless communication device to the second wireless communication device, the traffic of the SL session in the block of SL slots.

In some embodiments, the first wireless communication device includes a companion device and the second wireless communication device includes a wearable device, and the traffic includes extended reality traffic. In some embodiments, the block of SL slots includes a plurality of consecutive time slots for the SL session. In some embodiments, the method includes switching, by the first wireless communication device, from an active mode to a sleep mode, after an end of a terminal time slot of the block of SL slots. In some embodiments, the first wireless communication device remains in the sleep mode for a duration corresponding to a scheduling periodicity of the SL session.

In some embodiments, the SL session is established on a first sub-channel, the method may include, while transmitting the traffic to the second wireless communication device sensing, by the first wireless communication device, one or more conditions of a second sub-channel. In some embodiments, the first wireless communication device includes a first radio frequency (RF) chain and a second RF chain. The traffic may be transmitted to the second wireless communication device via the first RF chain, and the one or more conditions are sensed via the second RF chain. In some embodiments, transmitting the traffic of the SL session in the block of SL slots is for a first round of the SL session. The method may include switching, by the first wireless communication device, from the first sub-channel to the second sub-channel for a second round of the SL session, according to the one or more conditions.

In another aspect, this disclosure is directed to a first wireless communication device including a transceiver and one or more processors configured to establish a sidelink (SL) session with a second wireless communication device. The one or more processors may be configured to reserve a block of SL slots for transmission of traffic between the first wireless communication device and the second wireless communication device. The one or more processors may be configured to transmit, via the wireless transceiver, to the second wireless communication device, the traffic of the SL session in the block of SL slots.

In some embodiments, the first wireless communication device includes a companion device and the second wireless communication device includes a wearable device, and the traffic includes extended reality traffic. In some embodiments, the block of SL slots includes a plurality of consecutive time slots for the SL session. In some embodiments, the one or more processors are further configured to switch, from an active mode to a sleep mode, after an end of a terminal time slot of the block of SL slots. In some embodiments, the first wireless communication device remains in the sleep mode for a duration corresponding to a scheduling periodicity of the SL session.

In some embodiments, the SL session is established on a first sub-channel, and the transceiver is configured to, while transmitting the traffic to the second wireless communication device, sense one or more conditions of a second sub-channel. In some embodiments, the transceiver comprises a full duplex transceiver comprising a first radio frequency (RF) chain and a second RF chain. The traffic may be transmitted to the second wireless communication device via the first RF chain, and the one or more conditions are sensed via the second RF chain. In some embodiments, transmitting the traffic of the SL session in the block of SL slots is for a first round (e.g., cycle) of the SL session. The one or more processors may be further configured to switch, via the transceiver, from the first sub-channel to the second sub-channel for a second round of the SL session, according to the one or more conditions.

In another aspect, this disclosure is directed to a first wireless communication device including a transceiver and one or more processors configured to establish a sidelink (SL) session with a second wireless communication device. The one or more processors may be configured to determine a block of SL slots for transmission of traffic between the first wireless communication device and the second wireless communication device. The one or more processors may be configured to receive, via the transceiver, from the second wireless communication device, the traffic of the SL session in the block of SL slots.

In some embodiments, the first wireless communication device comprises a wearable device and the second wireless communication device comprises a companion device, and the traffic includes extended reality traffic. In some embodiments, the block of SL slots comprises a plurality of consecutive time slots for the SL session. In some embodiments, the one or more processors are further configured to switch, from an active mode to a sleep mode, after an end of a terminal time slot of the block of SL slots, where the first wireless communication device remains in the sleep mode for a duration corresponding to a scheduling periodicity of the SL session.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing.

FIG. 1 is a diagram of an example wireless communication system, according to an example implementation of the present disclosure.

FIG. 2 is a diagram of a console and a head wearable display for presenting augmented reality or virtual reality, according to an example implementation of the present disclosure.

FIG. 3 is a diagram of a head wearable display, according to an example implementation of the present disclosure.

FIG. 4 is a block diagram of a computing environment according to an example implementation of the present disclosure.

FIG. 5 is a block diagram of a system for sidelink communication, according to an example implementation of the present disclosure.

FIG. 6 is a timing diagram illustrating communication of a plurality of device sets via sidelink communication, according to an example implementation of the present disclosure.

FIGS. 7A and 7B are flowcharts showing example methods for sidelink communication, according to an example implementation of the present disclosure.

FIG. 8 is a flowchart showing an example method for sidelink communication, according to an example implementation of the present disclosure.

### DETAILED DESCRIPTION

Before turning to the figures, which illustrate certain embodiments in detail, it should be understood that the present disclosure is not limited to the details or methodology set forth in the description or illustrated in the figures. It should also be understood that the terminology used herein is for the purpose of description only and should not be regarded as limiting.

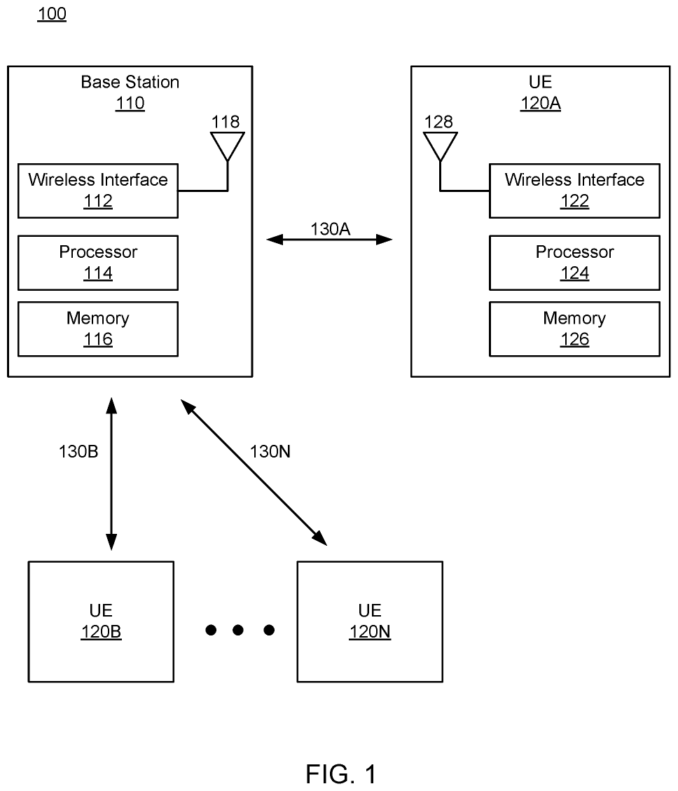

FIG. 1 illustrates an example wireless communication system 100. The wireless communication system 100 may include a base station 110 (also referred to as “a wireless communication node 110” or “a station 110”) and one or more user equipment (UEs) 120 (also referred to as “wireless communication devices 120” or “terminal devices 120”). The base station 110 and the UEs 120 may communicate through wireless commination links 130A, 130B, 130C. The wireless communication link 130 may be a cellular communication link conforming to 3G, 4G, 5G or other cellular communication protocols or a Wi-Fi communication protocol. In one example, the wireless communication link 130 supports, employs or is based on an orthogonal frequency division multiple access (OFDMA). In one aspect, the UEs 120 are located within a geographical boundary with respect to the base station 110, and may communicate with or through the base station 110. In some embodiments, the wireless communication system 100 includes more, fewer, or different components than shown in FIG. 1. For example, the wireless communication system 100 may include one or more additional base stations 110 than shown in FIG. 1.

In some embodiments, the UE 120 may be a user device such as a mobile phone, a smart phone, a personal digital assistant (PDA), tablet, laptop computer, wearable computing device, etc. Each UE 120 may communicate with the base station 110 through a corresponding communication link 130. For example, the UE 120 may transmit data to a base station 110 through a wireless communication link 130, and receive data from the base station 110 through the wireless communication link 130. Example data may include audio data, image data, text, etc. Communication or transmission of data by the UE 120 to the base station 110 may be referred to as an uplink communication. Communication or reception of data by the UE 120 from the base station 110 may be referred to as a downlink communication. In some embodiments, the UE 120A includes a wireless interface 122, a processor 124, a memory device 126, and one or more antennas 128. These components may be embodied as hardware, software, firmware, or a combination thereof. In some embodiments, the UE 120A includes more, fewer, or different components than shown in FIG. 1. For example, the UE 120 may include an electronic display and/or an input device. For example, the UE 120 may include additional antennas 128 and wireless interfaces 122 than shown in FIG. 1.

The antenna 128 may be a component that receives a radio frequency (RF) signal and/or transmit a RF signal through a wireless medium. The RF signal may be at a frequency between 200 MHz to 100 GHz. The RF signal may have packets, symbols, or frames corresponding to data for communication. The antenna 128 may be a dipole antenna, a patch antenna, a ring antenna, or any suitable antenna for wireless communication. In one aspect, a single antenna 128 is utilized for both transmitting the RF signal and receiving the RF signal. In one aspect, different antennas 128 are utilized for transmitting the RF signal and receiving the RF signal. In one aspect, multiple antennas 128 are utilized to support multiple-in, multiple-out (MIMO) communication.

The wireless interface 122 includes or is embodied as a transceiver for transmitting and receiving RF signals through a wireless medium. The wireless interface 122 may communicate with a wireless interface 112 of the base station 110 through a wireless communication link 130A. In one configuration, the wireless interface 122 is coupled to one or more antennas 128. In one aspect, the wireless interface 122 may receive the RF signal at the RF frequency received through antenna 128, and downconvert the RF signal to a baseband frequency (e.g., 0˜1 GHZ). The wireless interface 122 may provide the downconverted signal to the processor 124. In one aspect, the wireless interface 122 may receive a baseband signal for transmission at a baseband frequency from the processor 124, and upconvert the baseband signal to generate a RF signal. The wireless interface 122 may transmit the RF signal through the antenna 128.

The processor 124 is a component that processes data. The processor 124 may be embodied as field programmable gate array (FPGA), application specific integrated circuit (ASIC), a logic circuit, etc. The processor 124 may obtain instructions from the memory device 126, and executes the instructions. In one aspect, the processor 124 may receive downconverted data at the baseband frequency from the wireless interface 122, and decode or process the downconverted data. For example, the processor 124 may generate audio data or image data according to the downconverted data, and present an audio indicated by the audio data and/or an image indicated by the image data to a user of the UE 120A. In one aspect, the processor 124 may generate or obtain data for transmission at the baseband frequency, and encode or process the data. For example, the processor 124 may encode or process image data or audio data at the baseband frequency, and provide the encoded or processed data to the wireless interface 122 for transmission.

The memory device 126 is a component that stores data. The memory device 126 may be embodied as random access memory (RAM), flash memory, read only memory (ROM), erasable programmable read-only memory (EPROM), electrically erasable programmable read-only memory (EEPROM), registers, a hard disk, a removable disk, a CD-ROM, or any device capable for storing data. The memory device 126 may be embodied as a non-transitory computer readable medium storing instructions executable by the processor 124 to perform various functions of the UE 120A disclosed herein. In some embodiments, the memory device 126 and the processor 124 are integrated as a single component.

In some embodiments, each of the UEs 120B . . . 120N includes similar components of the UE 120A to communicate with the base station 110. Thus, detailed description of duplicated portion thereof is omitted herein for the sake of brevity.

In some embodiments, the base station 110 may be an evolved node B (eNB), a serving eNB, a target eNB, a femto station, or a pico station. The base station 110 may be communicatively coupled to another base station 110 or other communication devices through a wireless communication link and/or a wired communication link. The base station 110 may receive data (or a RF signal) in an uplink communication from a UE 120. Additionally or alternatively, the base station 110 may provide data to another UE 120, another base station, or another communication device. Hence, the base station 110 allows communication among UEs 120 associated with the base station 110, or other UEs associated with different base stations. In some embodiments, the base station 110 includes a wireless interface 112, a processor 114, a memory device 116, and one or more antennas 118. These components may be embodied as hardware, software, firmware, or a combination thereof. In some embodiments, the base station 110 includes more, fewer, or different components than shown in FIG. 1. For example, the base station 110 may include an electronic display and/or an input device. For example, the base station 110 may include additional antennas 118 and wireless interfaces 112 than shown in FIG. 1.

The antenna 118 may be a component that receives a radio frequency (RF) signal and/or transmit a RF signal through a wireless medium. The antenna 118 may be a dipole antenna, a patch antenna, a ring antenna, or any suitable antenna for wireless communication. In one aspect, a single antenna 118 is utilized for both transmitting the RF signal and receiving the RF signal. In one aspect, different antennas 118 are utilized for transmitting the RF signal and receiving the RF signal. In one aspect, multiple antennas 118 are utilized to support multiple-in, multiple-out (MIMO) communication.

The wireless interface 112 includes or is embodied as a transceiver for transmitting and receiving RF signals through a wireless medium. The wireless interface 112 may communicate with a wireless interface 122 of the UE 120 through a wireless communication link 130. In one configuration, the wireless interface 112 is coupled to one or more antennas 118. In one aspect, the wireless interface 112 may receive the RF signal at the RF frequency received through antenna 118, and downconvert the RF signal to a baseband frequency (e.g., 0˜1 GHZ). The wireless interface 112 may provide the downconverted signal to the processor 124. In one aspect, the wireless interface 122 may receive a baseband signal for transmission at a baseband frequency from the processor 114, and upconvert the baseband signal to generate a RF signal. The wireless interface 112 may transmit the RF signal through the antenna 118.

The processor 114 is a component that processes data. The processor 114 may be embodied as FPGA, ASIC, a logic circuit, etc. The processor 114 may obtain instructions from the memory device 116, and executes the instructions. In one aspect, the processor 114 may receive downconverted data at the baseband frequency from the wireless interface 112, and decode or process the downconverted data. For example, the processor 114 may generate audio data or image data according to the downconverted data. In one aspect, the processor 114 may generate or obtain data for transmission at the baseband frequency, and encode or process the data. For example, the processor 114 may encode or process image data or audio data at the baseband frequency, and provide the encoded or processed data to the wireless interface 112 for transmission. In one aspect, the processor 114 may set, assign, schedule, or allocate communication resources for different UEs 120. For example, the processor 114 may set different modulation schemes, time slots, channels, frequency bands, etc. for UEs 120 to avoid interference. The processor 114 may generate data (or UL CGs) indicating configuration of communication resources, and provide the data (or UL CGs) to the wireless interface 112 for transmission to the UEs 120.

The memory device 116 is a component that stores data. The memory device 116 may be embodied as RAM, flash memory, ROM, EPROM, EEPROM, registers, a hard disk, a removable disk, a CD-ROM, or any device capable for storing data. The memory device 116 may be embodied as a non-transitory computer readable medium storing instructions executable by the processor 114 to perform various functions of the base station 110 disclosed herein. In some embodiments, the memory device 116 and the processor 114 are integrated as a single component.

In some embodiments, communication between the base station 110 and the UE 120 is based on one or more layers of Open Systems Interconnection (OSI) model. The OSI model may include layers including: a physical layer, a Medium Access Control (MAC) layer, a Radio Link Control (RLC) layer, a Packet Data Convergence Protocol (PDCP) layer, a Radio Resource Control (RRC) layer, a Non Access Stratum (NAS) layer or an Internet Protocol (IP) layer, and other layer.

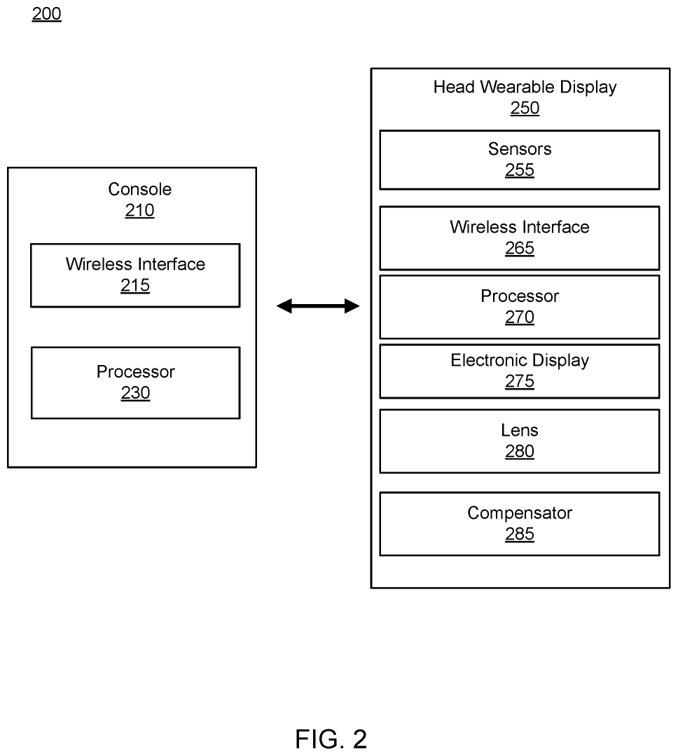

FIG. 2 is a block diagram of an example artificial reality system environment 200. In some embodiments, the artificial reality system environment 200 includes a HWD 250 worn by a user, and a console 210 providing content of artificial reality (e.g., augmented reality, virtual reality, mixed reality) to the HWD 250. Each of the HWD 250 and the console 210 may be a separate UE 120. The HWD 250 may be referred to as, include, or be part of a head mounted display (HMD), head mounted device (HMD), head wearable device (HWD), head worn display (HWD) or head worn device (HWD). The HWD 250 may detect its location and/or orientation of the HWD 250 as well as a shape, location, and/or an orientation of the body/hand/face of the user, and provide the detected location/or orientation of the HWD 250 and/or tracking information indicating the shape, location, and/or orientation of the body/hand/face to the console 210. The console 210 may generate image data indicating an image of the artificial reality according to the detected location and/or orientation of the HWD 250, the detected shape, location and/or orientation of the body/hand/face of the user, and/or a user input for the artificial reality, and transmit the image data to the HWD 250 for presentation. In some embodiments, the artificial reality system environment 200 includes more, fewer, or different components than shown in FIG. 2. In some embodiments, functionality of one or more components of the artificial reality system environment 200 can be distributed among the components in a different manner than is described here. For example, some of the functionality of the console 210 may be performed by the HWD 250. For example, some of the functionality of the HWD 250 may be performed by the console 210. In some embodiments, the console 210 is integrated as part of the HWD 250.

In some embodiments, the HWD 250 is an electronic component that can be worn by a user and can present or provide an artificial reality experience to the user. The HWD 250 may render one or more images, video, audio, or some combination thereof to provide the artificial reality experience to the user. In some embodiments, audio is presented via an external device (e.g., speakers and/or headphones) that receives audio information from the HWD 250, the console 210, or both, and presents audio based on the audio information. In some embodiments, the HWD 250 includes sensors 255, a wireless interface 265, a processor 270, an electronic display 275, a lens 280, and a compensator 285. These components may operate together to detect a location of the HWD 250 and a gaze direction of the user wearing the HWD 250, and render an image of a view within the artificial reality corresponding to the detected location and/or orientation of the HWD 250. In other embodiments, the HWD 250 includes more, fewer, or different components than shown in FIG. 2.

In some embodiments, the sensors 255 include electronic components or a combination of electronic components and software components that detect a location and an orientation of the HWD 250. Examples of the sensors 255 can include: one or more imaging sensors, one or more accelerometers, one or more gyroscopes, one or more magnetometers, or another suitable type of sensor that detects motion and/or location. For example, one or more accelerometers can measure translational movement (e.g., forward/back, up/down, left/right) and one or more gyroscopes can measure rotational movement (e.g., pitch, yaw, roll). In some embodiments, the sensors 255 detect the translational movement and the rotational movement, and determine an orientation and location of the HWD 250. In one aspect, the sensors 255 can detect the translational movement and the rotational movement with respect to a previous orientation and location of the HWD 250, and determine a new orientation and/or location of the HWD 250 by accumulating or integrating the detected translational movement and/or the rotational movement. Assuming for an example that the HWD 250 is oriented in a direction 25 degrees from a reference direction, in response to detecting that the HWD 250 has rotated 20 degrees, the sensors 255 may determine that the HWD 250 now faces or is oriented in a direction 45 degrees from the reference direction. Assuming for another example that the HWD 250 was located two feet away from a reference point in a first direction, in response to detecting that the HWD 250 has moved three feet in a second direction, the sensors 255 may determine that the HWD 250 is now located at a vector multiplication of the two feet in the first direction and the three feet in the second direction.

In some embodiments, the sensors 255 include eye trackers. The eye trackers may include electronic components or a combination of electronic components and software components that determine a gaze direction of the user of the HWD 250. In some embodiments, the HWD 250, the console 210 or a combination of them may incorporate the gaze direction of the user of the HWD 250 to generate image data for artificial reality. In some embodiments, the eye trackers include two eye trackers, where each eye tracker captures an image of a corresponding eye and determines a gaze direction of the eye. In one example, the eye tracker determines an angular rotation of the eye, a translation of the eye, a change in the torsion of the eye, and/or a change in shape of the eye, according to the captured image of the eye, and determines the relative gaze direction with respect to the HWD 250, according to the determined angular rotation, translation and the change in the torsion of the eye. In one approach, the eye tracker may shine or project a predetermined reference or structured pattern on a portion of the eye, and capture an image of the eye to analyze the pattern projected on the portion of the eye to determine a relative gaze direction of the eye with respect to the HWD 250. In some embodiments, the eye trackers incorporate the orientation of the HWD 250 and the relative gaze direction with respect to the HWD 250 to determine a gate direction of the user. Assuming for an example that the HWD 250 is oriented at a direction 30 degrees from a reference direction, and the relative gaze direction of the HWD 250 is −10 degrees (or 350 degrees) with respect to the HWD 250, the eye trackers may determine that the gaze direction of the user is 20 degrees from the reference direction. In some embodiments, a user of the HWD 250 can configure the HWD 250 (e.g., via user settings) to enable or disable the eye trackers. In some embodiments, a user of the HWD 250 is prompted to enable or disable the eye trackers.

In some embodiments, the wireless interface 265 includes an electronic component or a combination of an electronic component and a software component that communicates with the console 210. The wireless interface 265 may be or correspond to the wireless interface 122. The wireless interface 265 may communicate with a wireless interface 215 of the console 210 through a wireless communication link through the base station 110. Through the communication link, the wireless interface 265 may transmit to the console 210 data indicating the determined location and/or orientation of the HWD 250, and/or the determined gaze direction of the user. Moreover, through the communication link, the wireless interface 265 may receive from the console 210 image data indicating or corresponding to an image to be rendered and additional data associated with the image.

In some embodiments, the processor 270 includes an electronic component or a combination of an electronic component and a software component that generates one or more images for display, for example, according to a change in view of the space of the artificial reality. In some embodiments, the processor 270 is implemented as a part of the processor 124 or is communicatively coupled to the processor 124. In some embodiments, the processor 270 is implemented as a processor (or a graphical processing unit (GPU)) that executes instructions to perform various functions described herein. The processor 270 may receive, through the wireless interface 265, image data describing an image of artificial reality to be rendered and additional data associated with the image, and render the image to display through the electronic display 275. In some embodiments, the image data from the console 210 may be encoded, and the processor 270 may decode the image data to render the image. In some embodiments, the processor 270 receives, from the console 210 in additional data, object information indicating virtual objects in the artificial reality space and depth information indicating depth (or distances from the HWD 250) of the virtual objects. In one aspect, according to the image of the artificial reality, object information, depth information from the console 210, and/or updated sensor measurements from the sensors 255, the processor 270 may perform shading, reprojection, and/or blending to update the image of the artificial reality to correspond to the updated location and/or orientation of the HWD 250. Assuming that a user rotated his head after the initial sensor measurements, rather than recreating the entire image responsive to the updated sensor measurements, the processor 270 may generate a small portion (e.g., 10%) of an image corresponding to an updated view within the artificial reality according to the updated sensor measurements, and append the portion to the image in the image data from the console 210 through reprojection. The processor 270 may perform shading and/or blending on the appended edges. Hence, without recreating the image of the artificial reality according to the updated sensor measurements, the processor 270 can generate the image of the artificial reality.

In some embodiments, the electronic display 275 is an electronic component that displays an image. The electronic display 275 may, for example, be a liquid crystal display or an organic light emitting diode display. The electronic display 275 may be a transparent display that allows the user to see through. In some embodiments, when the HWD 250 is worn by a user, the electronic display 275 is located proximate (e.g., less than 3 inches) to the user's eyes. In one aspect, the electronic display 275 emits or projects light towards the user's eyes according to image generated by the processor 270.

In some embodiments, the lens 280 is a mechanical component that alters received light from the electronic display 275. The lens 280 may magnify the light from the electronic display 275, and correct for optical error associated with the light. The lens 280 may be a Fresnel lens, a convex lens, a concave lens, a filter, or any suitable optical component that alters the light from the electronic display 275. Through the lens 280, light from the electronic display 275 can reach the pupils, such that the user can see the image displayed by the electronic display 275, despite the close proximity of the electronic display 275 to the eyes.

In some embodiments, the compensator 285 includes an electronic component or a combination of an electronic component and a software component that performs compensation to compensate for any distortions or aberrations. In one aspect, the lens 280 introduces optical aberrations such as a chromatic aberration, a pin-cushion distortion, barrel distortion, etc. The compensator 285 may determine a compensation (e.g., predistortion) to apply to the image to be rendered from the processor 270 to compensate for the distortions caused by the lens 280, and apply the determined compensation to the image from the processor 270. The compensator 285 may provide the predistorted image to the electronic display 275.

In some embodiments, the console 210 is an electronic component or a combination of an electronic component and a software component that provides content to be rendered to the HWD 250. In one aspect, the console 210 includes a wireless interface 215 and a processor 230. These components may operate together to determine a view (e.g., a FOV of the user) of the artificial reality corresponding to the location of the HWD 250 and the gaze direction of the user of the HWD 250, and can generate image data indicating an image of the artificial reality corresponding to the determined view. In addition, these components may operate together to generate additional data associated with the image. Additional data may be information associated with presenting or rendering the artificial reality other than the image of the artificial reality. Examples of additional data include, hand model data, mapping information for translating a location and an orientation of the HWD 250 in a physical space into a virtual space (or simultaneous localization and mapping (SLAM) data), eye tracking data, motion vector information, depth information, edge information, object information, etc. The console 210 may provide the image data and the additional data to the HWD 250 for presentation of the artificial reality. In other embodiments, the console 210 includes more, fewer, or different components than shown in FIG. 2. In some embodiments, the console 210 is integrated as part of the HWD 250.

In some embodiments, the wireless interface 215 is an electronic component or a combination of an electronic component and a software component that communicates with the HWD 250. The wireless interface 215 may be or correspond to the wireless interface 122. The wireless interface 215 may be a counterpart component to the wireless interface 265 to communicate through a communication link (e.g., wireless communication link). Through the communication link, the wireless interface 215 may receive from the HWD 250 data indicating the determined location and/or orientation of the HWD 250, and/or the determined gaze direction of the user. Moreover, through the communication link, the wireless interface 215 may transmit to the HWD 250 image data describing an image to be rendered and additional data associated with the image of the artificial reality.

The processor 230 can include or correspond to a component that generates content to be rendered according to the location and/or orientation of the HWD 250. In some embodiments, the processor 230 is implemented as a part of the processor 124 or is communicatively coupled to the processor 124. In some embodiments, the processor 230 may incorporate the gaze direction of the user of the HWD 250. In one aspect, the processor 230 determines a view of the artificial reality according to the location and/or orientation of the HWD 250. For example, the processor 230 maps the location of the HWD 250 in a physical space to a location within an artificial reality space, and determines a view of the artificial reality space along a direction corresponding to the mapped orientation from the mapped location in the artificial reality space. The processor 230 may generate image data describing an image of the determined view of the artificial reality space, and transmit the image data to the HWD 250 through the wireless interface 215. In some embodiments, the processor 230 may generate additional data including motion vector information, depth information, edge information, object information, hand model data, etc., associated with the image, and transmit the additional data together with the image data to the HWD 250 through the wireless interface 215. The processor 230 may encode the image data describing the image, and can transmit the encoded data to the HWD 250. In some embodiments, the processor 230 generates and provides the image data to the HWD 250 periodically (e.g., every 11 ms).

In one aspect, the process of detecting the location of the HWD 250 and the gaze direction of the user wearing the HWD 250, and rendering the image to the user should be performed within a frame time (e.g., 11 ms or 16 ms). A latency between a movement of the user wearing the HWD 250 and an image displayed corresponding to the user movement can cause judder, which may result in motion sickness and can degrade the user experience. In one aspect, the HWD 250 and the console 210 can prioritize communication for AR/VR, such that the latency between the movement of the user wearing the HWD 250 and the image displayed corresponding to the user movement can be presented within the frame time (e.g., 11 ms or 16 ms) to provide a seamless experience.

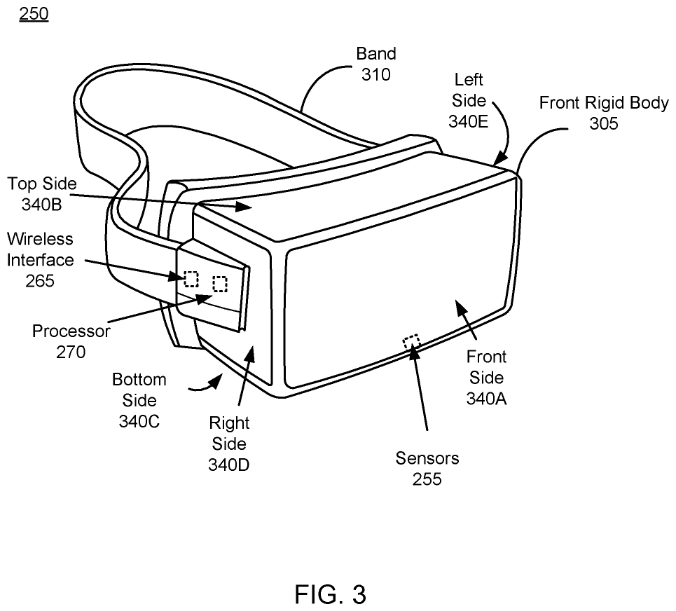

FIG. 3 is a diagram of a HWD 250, in accordance with an example embodiment. In some embodiments, the HWD 250 includes a front rigid body 305 and a band 310. The front rigid body 305 includes the electronic display 275 (not shown in FIG. 3), the lens 280 (not shown in FIG. 3), the sensors 255, the wireless interface 265, and the processor 270. In the embodiment shown by FIG. 3, the wireless interface 265, the processor 270, and the sensors 255 are located within the front rigid body 205, and may not be visible externally. In other embodiments, the HWD 250 has a different configuration than shown in FIG. 3. For example, the wireless interface 265, the processor 270, and/or the sensors 255 may be in different locations than shown in FIG. 3.

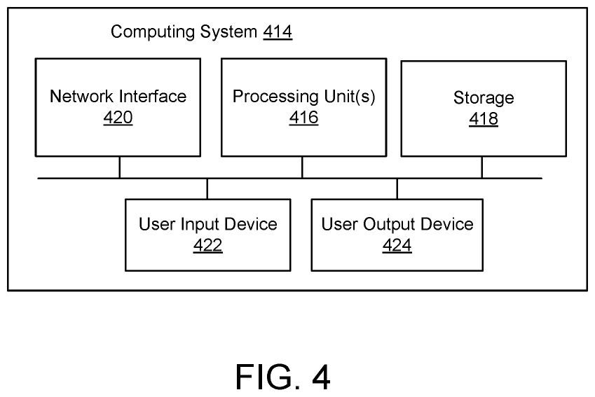

Various operations described herein can be implemented on computer systems. FIG. 4 shows a block diagram of a representative computing system 414 usable to implement the present disclosure. In some embodiments, the source devices 110, the sink device 120, the console 210, the HWD 250 are implemented by the computing system 414. Computing system 414 can be implemented, for example, as a consumer device such as a smartphone, other mobile phone, tablet computer, wearable computing device (e.g., smart watch, eyeglasses, head wearable display), desktop computer, laptop computer, or implemented with distributed computing devices. The computing system 414 can be implemented to provide VR, AR, MR experience. In some embodiments, the computing system 414 can include conventional computer components such as processors 416, storage device 418, network interface 420, user input device 422, and user output device 424.

Network interface 420 can provide a connection to a wide area network (e.g., the Internet) to which WAN interface of a remote server system is also connected. Network interface 420 can include a wired interface (e.g., Ethernet) and/or a wireless interface implementing various RF data communication standards such as Wi-Fi, Bluetooth, or cellular data network standards (e.g., 3G, 4G, 5G, 60 GHz, LTE, etc.).

The network interface 420 may include a transceiver to allow the computing system 414 to transmit and receive data from a remote device using a transmitter and receiver. The transceiver may be configured to support transmission/reception supporting industry standards that enables bi-directional communication. An antenna may be attached to transceiver housing and electrically coupled to the transceiver. Additionally or alternatively, a multi-antenna array may be electrically coupled to the transceiver such that a plurality of beams pointing in distinct directions may facilitate in transmitting and/or receiving data.

A transmitter may be configured to wirelessly transmit frames, slots, or symbols generated by the processor unit 416. Similarly, a receiver may be configured to receive frames, slots or symbols and the processor unit 416 may be configured to process the frames. For example, the processor unit 416 can be configured to determine a type of frame and to process the frame and/or fields of the frame accordingly.

User input device 422 can include any device (or devices) via which a user can provide signals to computing system 414; computing system 414 can interpret the signals as indicative of particular user requests or information. User input device 422 can include any or all of a keyboard, touch pad, touch screen, mouse or other pointing device, scroll wheel, click wheel, dial, button, switch, keypad, microphone, sensors (e.g., a motion sensor, an eye tracking sensor, etc.), and so on.

User output device 424 can include any device via which computing system 414 can provide information to a user. For example, user output device 424 can include a display to display images generated by or delivered to computing system 414. The display can incorporate various image generation technologies, e.g., a liquid crystal display (LCD), light-emitting diode (LED) including organic light-emitting diodes (OLED), projection system, cathode ray tube (CRT), or the like, together with supporting electronics (e.g., digital-to-analog or analog-to-digital converters, signal processors, or the like). A device such as a touchscreen that function as both input and output device can be used. Output devices 424 can be provided in addition to or instead of a display. Examples include indicator lights, speakers, tactile “display” devices, printers, and so on.

Some implementations include electronic components, such as microprocessors, storage and memory that store computer program instructions in a computer readable storage medium (e.g., non-transitory computer readable medium). Many of the features described in this specification can be implemented as processes that are specified as a set of program instructions encoded on a computer readable storage medium. When these program instructions are executed by one or more processors, they cause the processors to perform various operation indicated in the program instructions. Examples of program instructions or computer code include machine code, such as is produced by a compiler, and files including higher-level code that are executed by a computer, an electronic component, or a microprocessor using an interpreter. Through suitable programming, processor 416 can provide various functionality for computing system 414, including any of the functionality described herein as being performed by a server or client, or other functionality associated with message management services.

It will be appreciated that computing system 414 is illustrative and that variations and modifications are possible. Computer systems used in connection with the present disclosure can have other capabilities not specifically described here. Further, while computing system 414 is described with reference to particular blocks, it is to be understood that these blocks are defined for convenience of description and are not intended to imply a particular physical arrangement of component parts. For instance, different blocks can be located in the same facility, in the same server rack, or on the same motherboard. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Implementations of the present disclosure can be realized in a variety of apparatus including electronic devices implemented using any combination of circuitry and software.

Disclosed herein are related to systems and methods for performing sidelink communication. Sidelink communication between devices can experience high transfer latencies, particularly in scenarios with high traffic loads, limited bandwidth, and/or external interference. Such latencies may occur due to the periodic nature of resource scheduling in a semi-persistent scheme (SPS) (e.g., 3GPP SL Mode 2). The periodic nature of resource scheduling may not be well-suited for traffic which is bursty in nature (such as AR/VR/MR traffic). With a 2 ms scheduling periodicity (RRI), the latency of the last sidelink (SL) packet (or TB) sent in a traffic interval, e.g., the overall SL transfer latency, may become high. Some standards may define a “dynamic scheme,” where the transmitting device using a SL selects a new time-frequency resource for each TB. The dynamic scheme may be more suited for aperiodic traffic. However, if all SL devices in a network use the dynamic scheme, the channel access may become equivalent to random resource selection, degrading system-wide reliability.

The systems and methods described herein relate to improvements of using 5G sidelink communication for supporting wireless communication. An AR or VR device (or other sidelink device) may communicate with a companion device (such as a smartphone) via a sidelink connection, to leverage the cellular connection of the companion device with the cellular network. Some sidelink communication protocols may only allot one transmission per reservation on a channel which cycles at a rate or interval (e.g., RRI). Such allotment may cause latency issues when transmitting large amounts of data. This solution allows a device to define (e.g., in their sidelink control information (SCI)) packet, a number of slots in which the device is to use for transmitting data. Each of the slots may be adjacent (e.g., in the time domain) to one another, thus permitting the device to transmit more data over a single cycle. Additionally, some sidelink communication protocols may only permit half-duplex communication and sensing, which can also contribute to delays. This solution allows the device to listen (e.g., on a different channel) while transmitting data within the device's defined slot. By listening on a different channel, the device can potentially hop to less noisy channels after completing the transmission.

Such implementations and embodiments may provide reduced latency by a device selecting the number of slots that the device is to use for transmitting data. Additionally, such implementations and embodiments may provide for reduced latency and less interference across available channels, by the device performing full duplex sensing and communication, thereby listening on different channel(s) while transmitting data within the device's defined slot(s).

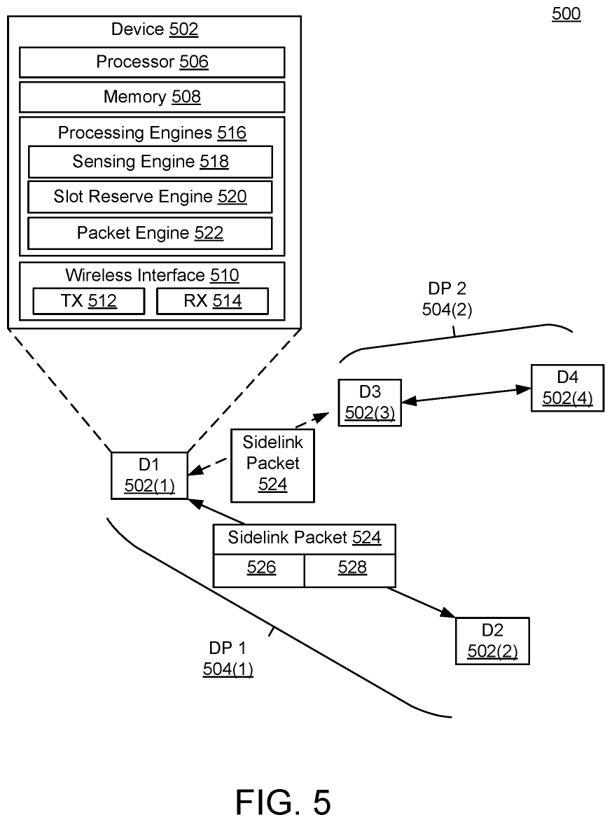

Referring now to FIG. 5, depicted is a block diagram of a system 500 for sidelink communication, according to an example implementation of the present disclosure. The system 500 can include a plurality of device pairs (DPs) or device sets, including a first device 502(1) and a second device 502(2), which form a first device pair 504(1), and a third device 502(3) and a fourth device 502(4), which form a second device pair 504(2). While shown as two device pairs, it is noted that the system 500 can include any number of device pairs. As described in greater detail below, a device 502 (such as the first device 502(1)) may be configured to establish a sidelink (SL) session with another device 502(such as the second device 502(2)). The first device 502(1) may be configured to reserve a block of SL slots for transmission of traffic between the first and second devices 502(1), 502(2). The first device 502(1) may be configured to transmit (e.g., to the second device 502(2)) the traffic of the SL session in the block of SL slots.

The devices 502 (e.g., of a device pair 504) may be similar to the devices described above with reference to FIG. 1-FIG. 4. For example, one device 502 may be similar to the head wearable display 150 described above with reference to FIG. 1 and FIG. 2, and another device 502 may be similar to the console 110. In some embodiments, one of the devices 502 may be a smartphone or other cellular device. The devices 502 may be configured to communicate periodic data via the respective sidelink channels. For example, the devices 502 may be configured to communicate AR/VR data, sensing data, video call or conferencing data, or other types or forms of periodic data.

The devices 502 may include one or more processor(s) 506 and memory 508. The processor(s) 506 may be similar to the processor(s) 114, 124, 230, 270 described above with reference to FIG. 1-FIG. 2. The memory 508 may be similar to the memory 116, 126 described above with reference to FIG. 1. The devices 502 may include a wireless interface 510, including a transmitter (TX) 512 and receiver (RX) 514. The wireless interface 510 may be similar to the wireless interfaces 112, 122, 215, 265 described above with reference to FIG. 1 and FIG. 2. The transmitter 512 and receiver 514 may be or include separate or combined antennas (e.g., such as a wireless transceiver, similar to the antennas 118, 128 described above with reference to FIG. 1). The transmitter 512 and receiver 514 may form separate radio frequency (RF) chains (e.g., a first RF chain and a second RF chain). While two RF chains are shown to be included in the device 502 (e.g., one corresponding to a transmitter 512 and another corresponding to a receiver 514), any number of RF chains may be included in a device 502, based on the number of antennas of the device 502.

The devices 502 may include one or more processing engines 516. The processing engines 516 may be or include any device, component, element, or hardware designed or configured to perform various functions of the device 502. For example, the processing engines 516 may be or include the processor(s) 506 configured by instructions in memory 508 to perform certain functions. The processing engines 516 may include a sensing engine 518, a slot reserve engine 520, and a packet engine 522. While these three processing engines 516 are shown and described, in various embodiments, some processing engines 516 may be combined with other processing engines 516 and/or some processing engines 516 may be separated into multiple processing engines 516. Additionally, and in various implementations, additional processing engines 516 (other than those shown in FIG. 5) may be implemented in a device 502.

While the components shown in FIG. 5 are described with reference to the first device 502, in various embodiments, each of the devices 502(2)-(4) may include similar elements or hardware as shown in FIG. 1. In some implementations, some devices 502 may include separate transmitters 512 and receivers 514, such that such devices 502 may be configured for duplex sensing and communication. Some devices 502 may include a single transceiver used both for wireless communication, such that the device 502 may be configured for half-duplex sensing and communication.

The devices 502 may be configured to generate, maintain, or otherwise establish a sidelink session over a sidelink channel. In some embodiments, the devices 502 may be configured to establish the sidelink session by performing device discovery. For example, one device 502(1) may be configured to broadcast (e.g., via the transmitter 512) various broadcast information for establishing a sidelink session. Such broadcast information may include, for instance, device identity information, capability information, resource pool information, timing and synchronization information, power control information, etc. A receiving device 502(2) may be configured to identify, detect, or otherwise receive the broadcast information from the transmitting device 502(1). The receiving device 502(2) and transmitting device 502(1) may be configured to negotiate various parameters for establishing a sidelink session.

In some embodiments, the sensing engine 518 may be configured to quantify, identify, determine, measure, or otherwise sense one or more channel conditions of a channel on which to establish the SL session. For example, the sensing engine 518 may be configured to identify (e.g., via one or more signals received via the receiver 514) a signal to interference plus noise (SINR) on one or more channels, any channel occupancy, a signal strength of a received signal from a transmitting device 502, etc. The sensing engine 518 may be configured to sense the channel conditions of a channel, to select the sidelink channel in which to establish the sidelink session. In various embodiments, a limited number of channels may be reserved for sidelink sessions. In some embodiments, the sensing engine 518 may be configured to sense condition(s) of one or more of the limited number of channels reserved for sidelink sessions, to select the corresponding sidelink channel.

Each device pair may be configured to communicate via a respective sidelink channel. For example, the first device 502(1) may be configured to communicate with the first device 502(2) via a sidelink channel, and the third device 502(3) may be configured to communicate with the fourth device 502(4) via a sidelink channel. In some embodiments, each sidelink channel may be on the same frequency channel or bandwidth. For example, a limited number of frequency channels or bandwidths may be reserved for sidelink channels between devices. As such, the device pairs in an environment may, in some instances, operate on a common frequency channel or bandwidth.

As part of establishing the sidelink session, the devices 502 may be configured to negotiate, establish, or otherwise determine a periodicity of the sidelink channel. The periodicity may be or include a resource reservation interval (RRI), or a time interval between consecutive resource reservation requests made by the devices 502. In some embodiments, the device 502 may be configured to determine or set the RRI based on various applications or resources executing on the device 502 (e.g., and to be supported by or otherwise exchange data/traffic for the SL session). In some embodiments, the device 502 may be configured to determine or set the RRI based on a congestion of the communication link. Each of the devices 502 may have a respective RRI value for their corresponding sidelink channel.

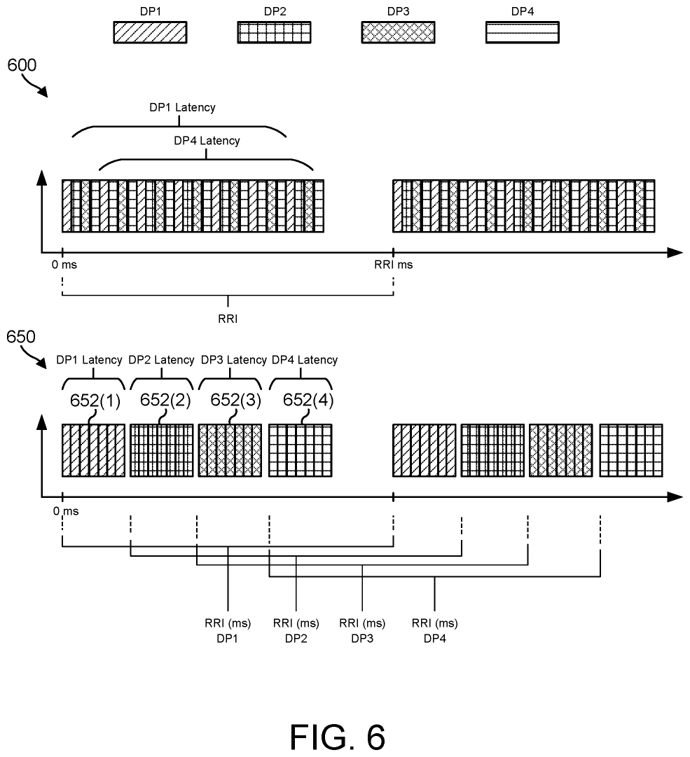

Referring briefly to FIG. 6, depicted is a timing diagram showing a first and second slot reservation scheme 600, 650, in which slots are reserved by a plurality of device pairs (DPs) in an environment. The device pairs may be similar to the device pairs 504 described above with reference to FIG. 5. In the example shown in FIG. 6, the environment may include four device pairs (e.g., four pairs of devices 502 which have separately established a sidelink session). While four device pairs are shown, any number of device pairs may be included in an environment.

In the first slot reservation scheme 600, device pairs may not schedule successive slots. Rather, as shown in FIG. 6, each device pair 604 may have, e.g., seven slots scheduled which are scheduled periodically over 28 total slots. In this regard, a first device pair (DP1) may have reserved the first, fifth, ninth, 13^{th}, 17^{th}, 21^{st}, and 25^{th} slots. Similarly, a fourth device pair (DP4) may have reserved the fourth, eighth, 12^{th}, 16^{th}, 20^{th}, 24^{th}, and 28^{th} slots. In such an arrangement, the device pairs 604 may experience latency spanning between the first and last slots of a particular period of the sidelink channel. For example, the first device pair (DP1) may experience latency spanning between the first slot and the 25^{th} slot, as shown in FIG. 6.

In the second slot reservation scheme 650, device pairs may be configured to schedule successive or consecutive (e.g., in time domain) slots as part of a block 652 (or block of a plurality of sidelink slots). As shown in FIG. 6, in the second slot reservation scheme 650, each device pair may include a respective block of sidelink slots 652 (e.g., a first block 652(1) for the first device pair, a second block 652(2) for the second device pair, a third block 652(3) for the third device pair, and a fourth block 652(4) for the fourth device pair). While each of the blocks are shown as including the same number of slots, it is noted that a device pair may reserve any number of slots within a given period of the sidelink session. In various embodiments, a device pair may reserve any number of slots within a given period, up to a slot limit. For example, the slot limit may be set by a standard, may be separately negotiated or determined based on the number of device pairs in an environment, etc. For example, the slot limit in the example shown in FIG. 6 may be seven slots, such that a device pair may reserve any number of slots between one and seven slots.

In this example, the latency within a particular period of the sidelink channel may be reduced as shown in FIG. 6. For example, the first device pair (DP1) may reserve the first, e.g., seven slots. As such, the latency between the first and last slot of the slot block is reduced in this slot reservation scheme 650. Additionally, the first device pair (DP1) can enter a sleep or doze state earlier within the particular period of the sidelink channel (e.g., after the terminal slot of the slot block), and maintain the device pair in the doze state for the remainder of the period until the starting slot of the next slot block (e.g., the duration corresponding to the scheduling periodicity, or RRI). Such implementations can decrease latency relative to the first slot reservation scheme 600, and increase power save relative to the first slot reservation scheme 600 by increasing a duration in which the device pair can be in a sleep or doze state.

Referring to FIG. 5 and FIG. 6, the slot reserve engine 520 may be configured to identify, select, reserve, or otherwise determine a number of slots 602 to reserve, for transmitting traffic to the corresponding device 502 of the device pair 504. In some embodiments, the slot reserve engine 520 may be configured to determine the number of slots 602 based on the traffic which is to be sent by the transmitting devices 502 on the sidelink channel. The slot reserve engine 520 may be configured to determine the number of slots as a function of the bandwidth for each slot, a bit rate, and sampling/resolution of data or traffic to be transmitted. In some embodiments, the traffic may be/include periodic data. For example, the periodic traffic may be video or graphics traffic, audio traffic, sensor traffic, periodic control traffic, etc. The slot reserve engine 520 may be configured to determine an amount of traffic to be sent for one period of the sidelink session, based on the traffic type and corresponding information related thereto. For example, the slot reserve engine 520 may be configured to determine the amount of traffic based on a frame size (e.g., in bits/bytes/etc.) of video frames. The slot reserve engine 520 may be configured to determine the number of slots to reserve, based on the amount of traffic and various parameters according to the negotiated sidelink session (e.g., the resource reservation interval (RRI), slot time, sub-channel size, available bandwidth, etc.).

In some embodiments, the slot reserve engine 520 may be configured to determine the number of slots to reserve, for both devices of the device pair. For example, the slot reserve engine 520 may be configured to determine the number of slots for both devices. In this regard, one device 502 of a device pair 504 (e.g., a companion device) may be configured to select the number of requested slots on behalf of both device (e.g., both the companion device and another device). In this regard, one device 502 may be configured to perform sensing (e.g., via the sensing engine 518) and resource allocation, and thereby inform the other device 502 through a corresponding packet of the number of reserved slots.

The packet engine 522 may be configured to create, produce, generate, or otherwise provide sidelink packets 524. The packet engine 522 may be configured to generate the sidelink packets 524, to indicate or otherwise identify the number of requested slots reserved for the sidelink session. In some embodiments, the packet engine 522 may be configured to generate the sidelink packets 524, to indicate the number of requested slots for both devices of the device pair. In some embodiments, the sidelink packets 524 may be or include sidelink communication interface (SCI) packets 524. The sidelink packets 524 may include a non-encoded portion 526 and an encoded portion 528. The non-encoded portion 526 may include negotiated information, such as sub-channel(s) of the sidelink channel which are reserved by the respective device 502, the periodicity or RRI, the number of slots determined (e.g., by the slot reserve engine 520) for the device 502, and a start time. The encoded portion 528 may include the data which is sent by the transmitting device 502 to the receiving device 502 on the sidelink channel.

The packet engine 522 may be configured to encode the encoded portion 528, for decoding by the intended receiving device 502 on the sidelink channel. For example, the devices 502 may include respective encoders/decoders (e.g., of the packet engine 522) which are configured (e.g., as part of negotiation) to respectively encode and decode traffic sent between the devices 502 on the sidelink channel. However, because such encoders and decoders are configured as part of negotiation, other devices which receive the packet 524 may not be configured to decode the encoded portion 528 of packets 524 which are not intended for the receiving device 502.

The transmitter 512 may be configured to broadcast or transmit the sidelink packet(s) 524 on the sidelink channel. In some embodiments, the transmitter 512 may be configured to transmit a plurality of sidelink packets 524, where each packet 524 is sent in a respective reserved slot of the slot block (e.g., reserved by the slot reserve engine 520). Other devices 502 which receive the sidelink packet 524 may be configured to determine the information included in the non-encoded portion 526 (e.g., such as the reserved slots, start time, etc.). However, because the sidelink packet 524 includes the encoded portion 528, the other transmitting devices 502 may not be capable of or configured to decode the encoded portion 510 and observe the data included therein. Such other devices 502, in being informed of the number of reserved slots and start time, may be configured to reserve corresponding slots for their own sidelink sessions, so as to avoid interference while reducing latency (e.g., as shown in FIG. 6, according to the second slot reservation scheme 650).

Referring still to FIG. 5, and in some embodiments, the device 502 may be configured to perform full-duplex sensing and communication. In some embodiments, the wireless interface 510 may be configured to listen (e.g., via the receiver 514) to other sub-channels of the sidelink communication link, while (simultaneously) transmitting (e.g., via the transmitter 512) during reserved slot(s) the receiving device 502. The sensing engine 518 may be configured to control the receiver 514 to identify various metrics of the other sub-channels, while the transmitter 512 is transmitting on the reserved sub-channel for the sidelink session. The sensing engine 518 may be configured to listen to other sub-channels, to determine whether other sub-channels are less congested than the sub-channel on which the device 502 is currently using for sidelink communications. By performing full-duplex sensing and communication, the device 502 may be configured to hop to less congested sub-channels after completing transmitting during its reserved slots, without having to separately perform a listening procedure outside of its transmission. Such implementations may improve latency and throughput (by eliminating half-duplex sensing separate from communication), and may improve congestion by reducing the number of devices 502 on a given sub-channel.

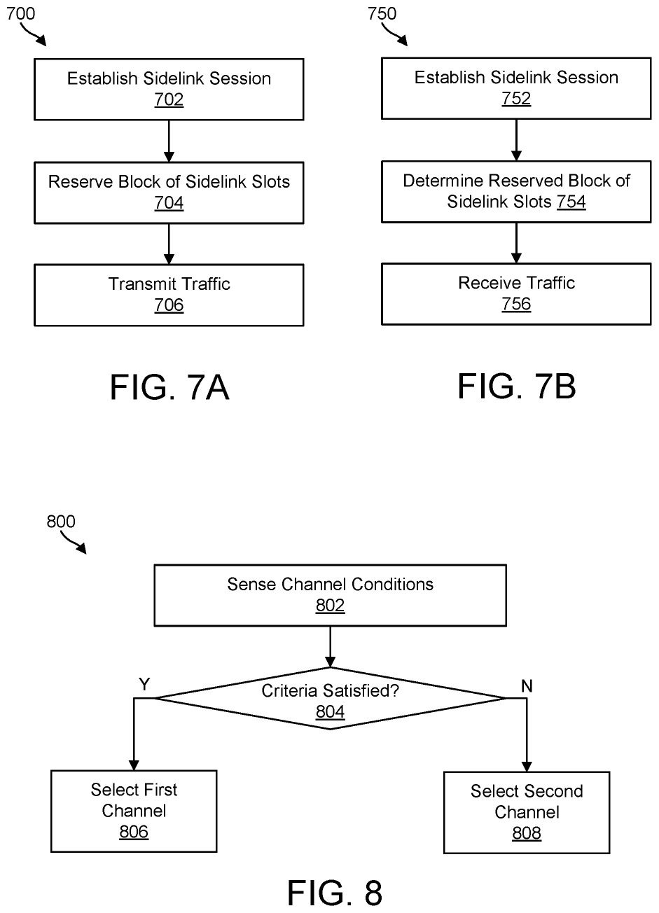

Referring now to FIG. 7A, depicted is a flowchart showing an example method 700 of sidelink communication, according to an example implementation of the present disclosure. The method 700 may be performed by the devices, components, elements, or hardware described above with reference to FIG. 1-FIG. 6. As a brief overview, at step 702, a first device may establish a sidelink session with a second device. At step 704, the first device may reserve a block of sidelink slots. At step 706, the first device may transmit traffic of the sidelink session to the second device.

At step 702, a first device may establish a sidelink session with a second device. In some embodiments, the first device may establish the sidelink session with the second device, responsive to one or more users of the device (e.g., located in the same environment) requesting the sidelink session on the respective devices. For example, the sidelink session may be established responsive to launching an application (e.g., an augmented reality, virtual reality, or other extended reality application which involves data communication between the requested devices via a sidelink session), responsive to a request to initiate communications between the devices, and so forth. In some embodiments, the first device and second device may be or include a companion device and a wearable device (e.g., as part of an extended reality device pair).

In some embodiments, the first device may select a channel or sub-channel on which to establish the sidelink session. The first device may select the channel by sensing various channel conditions of the channel or sub-channel, and identifying or selecting the channel based on such channel conditions. Additional details regarding the selection of the channel are described with reference to FIG. 8. The first device may establish the sidelink session by broadcasting information (e.g., on the selected channel or sub-channel) relating to a requested session (e.g., device identity information, capability information, resource pool, timing and synchronization information). The second device may receive the broadcast information, and can generate a response to negotiate various parameters for establishing the sidelink session.

At step 704, the first device may reserve a block of sidelink slots. In some embodiments, the first device may reserve/designate/schedule a block of sidelink slots, for transmission of traffic between the first device and the second device. The first device may reserve the block of sidelink slots, according to the traffic which is to be transmitted between the first device and the second device. For example, the first device may reserve the block of sidelink slots, based on both the traffic to be sent by the first device to the second device, and the traffic to be sent by the second device to the first device. In this regard, the first device may reserve the block of sidelink slots to be used by both the first device and the second device.

In some embodiments, the first device may select the number of slots in which to reserve according to the traffic. For example, the device may determine the number of slots based on a traffic type of the traffic, and a configuration of the sidelink session. The configuration of the sidelink session may include, for instance, a periodicity of rounds of the sidelink session (such as a resource reservation interval), a slot duration of the slots of a corresponding round, and so forth. The configuration of the sidelink session may be set according to various standards, negotiated as part of establishing the sidelink session, etc. The device may determine the number of slots, based on a data size of traffic which is to be sent between the devices for a given round, and the configuration of the sidelink session. For example, the device may determine the number of slots of the blocks according to a frame rate for video, a sample rate for audio/sensor data, a refresh rate of control information, etc., and their corresponding estimated data size.

In some embodiments, the first device may generate one or more packets. The one or more packets may include, for example, sidelink communication interface (SCI) packets. The first device may generate the one or more packets, to indicate or otherwise identify the number of reserved slots. In some embodiments, the first device may generate the one or more packets to include sidelink configuration information (e.g., the number of reserved slots and a start time of a first slot of the block). In some embodiments, the first device may generate the one or more packets to include data corresponding to the traffic to be sent by the first device to the second device. The first device may generate the packet(s), by encoding a first portion of the packet(s) which include the data corresponding to the traffic, while maintaining a second portion including the sidelink configuration information unencoded. In this regard, the packet(s) may include an encoded portion and an un-encoded portion, where the encoded portion includes data corresponding to the traffic and the un-encoded portion includes the sidelink configuration information. As such, an intended receiving device may decode the encoded portion to receive the data corresponding to the traffic, and any receiving device may determine the sidelink configuration information (which can be used for configuring their own respective sidelink sessions).

At step 706, the first device may transmit traffic of the sidelink session to the second device. In some embodiments, the first device may transmit the traffic within the block of slots of the sidelink session to the second device. The first device may transmit the traffic on the selected channel or sub-channel to the second device. The first device may transmit the traffic, by transmitting one or more packets in a corresponding slot of the block of slots, to the second device. The first device may transmit the traffic via a radio frequency (RF) chain of the first device, to the second device. In some embodiments, the first device may transmit the traffic, by transmitting a plurality of packets generated by the first device, in respective slots of the slot block. For example, the first device may transmit a plurality of SCI packets generated by the first device, where each SCI packet includes a respective portion of the traffic to be transmitted to the second device.

In some embodiments, the first device may also receive traffic of the sidelink session from the second device. For example, the first device may receive traffic sent by the second device during at least some of the slots of the block of slots. In some embodiments, the first device may transmit traffic of the sidelink session within a first subset of slots of the block of slots, and the first device may receive other traffic of the sidelink session from the second device within a second subset of slots of the block of slots.

In some embodiments, the first device (and second device) may enter or switch to a sleep (or doze) mode, responsive to an end of the block of sidelink slots. For example, since the block of sidelink slots are reserved for both the first and second devices, both the first device and the second device may enter a sleep mode (or sleep state) after a terminal (e.g., last, final) time slot of the block of sidelink slots. The devices may be maintained in the sleep mode for a duration corresponding to the scheduling periodicity (e.g., the RRI) of the sidelink session.

Referring now to FIG. 7B, depicted is a flowchart showing another example method 750 of sidelink communication, according to an example implementation of the present disclosure. Similar to the method 700, the method 750 may be performed by the devices, components, elements, or hardware described above with reference to FIG. 1-FIG. 6. In some embodiments, the method 700 may be performed by one device (such as a companion device), and the method 750 may be performed by another device (such as a wearable device), of a device pair corresponding to the sidelink session. As a brief overview, at step 752, a second device may establish a sidelink session. At step 754, the second device may determine a reserved block of sidelink slots. At step 756, the second device may receive traffic of the sidelink session.

At step 752, a second device may establish a sidelink session. Step 752 may be similar to (e.g., complementary to) step 702 of FIG. 7A. For example, the second device may establish the sidelink session as part of session negotiation between the first and second devices. The second device may establish the sidelink session with the first device, responsive to the first device broadcasting session information. The second device may establish the sidelink session, by generating a response to the session information broadcast by the first device at step 702. The second device may establish the session, by negotiating various session configuration information or parameters with the first device.

At step 754, the second device may determine a reserved block of sidelink slots. In some embodiments, the second device may determine the reserved block of sidelink slots for transmission of traffic between the first device and the second device. For example, the second device may determine the reserved block of sidelink slots, responsive to the first device reserving the number of sidelink blocks (e.g., at step 704). The second device may determine the reserved block of sidelink slots, based on or according to a sidelink packet received by the second device from the first device. For example, the second device may determine the reserved block of slots according to non-encoded information included in a SCI packet generated by the first device.

At step 756, the second device may receive traffic of the sidelink session. In some embodiments, the second device may receive traffic of the sidelink session on the channel or sub-channel selected by the first device. The second device may receive the traffic transmitted by the first device, at step 706 of FIG. 7A. The second device may receive the traffic as a plurality of packets sent by the first device in one or more of the plurality of slots. In some embodiments, the traffic received by the second device may be extended reality traffic. For example, the traffic may be video or graphics traffic, audio traffic, etc. In some embodiments, method 750 may further include the second device transmitting traffic of the sidelink session to the first device. For example, the second device may transmit traffic of the sidelink session to the first device in one or more other slots of the slot block to the first device. The second device may, for example, transmit other extended reality traffic, such as audio traffic, user inputs, sensor data, etc.

Referring now to FIG. 8, depicted is a flowchart showing an example method 800 of sidelink communication, according to an example implementation of the present disclosure. The method 800 may be performed by the devices, components, elements, or hardware described above with reference to FIG. 1-FIG. 6. In some embodiments, the method 800 may be performed during (e.g., simultaneously or in parallel with) step 706 of method 700. For example, the method 800 may be performed as part of a full-duplex sensing and communication by a device. In some embodiments, some steps of method 800 may be performed as part of step 702 of FIG. 7A. For example, such steps may be performed as part of selecting a channel or sub-channel on which to establish the sidelink session. In other words, at least some steps of method 800 may be performed as part of or in connection with the method 700 of FIG. 7A. As a brief overview, at step 802, a first device may sense/detect/measure one or more channel conditions. At step 804, the first device may determine whether the one or more channel conditions satisfy a criteria. At step 806, the first device may select the channel. At step 808, the first device may hop/transition/switch to a different channel.

At step 802, a first device may sense one or more channel conditions. In some embodiments, the first device may sense one or more channel conditions via a radio frequency (RF) chain of the first device. In some embodiments, the first device may sense the channel condition(s) as part of selecting a channel or sub-channel in which to establish the session. For example, the first device may sense, measure, or otherwise identify channel conditions of one or more channels or sub-channels reserved for sidelink communications. The channel conditions may include, for example, a signal to interference plus noise ratio (SINR), a channel occupancy, a received signal strength indicator (RSSI), etc. The first device may select the channel or sub-channel in which to establish the session, based on the channel conditions satisfying one or more criterion (as described below).

In some embodiments, the first device may sense the channel condition(s) via one RF chain of the first device, while another RF chain of the first device transmits traffic to the second device. For example, the first device may sense the channel condition(s) in parallel with (e.g., simultaneously with) step 706 of FIG. 7A. In this regard, the first device may be a full-duplex sensing and communication device, including two (or more) RF chains. The first device may sense the channel condition(s) in parallel with transmitting traffic, to determine whether to hop or switch to a different channel or sub-channel (e.g., for a subsequent round of the sidelink session).

At step 804, the first device may determine whether the one or more channel conditions satisfy a criteria. In some embodiments, the device may determine whether the sensed conditions at step 802 satisfy a channel selection criteria. The channel selection criteria may be or include a threshold SINR, whether a channel is occupied, a threshold RSSI, and so forth. The first device may compare the one or more channel conditions to the selection criteria. Where, at step 804, the channel selection criteria is satisfied, the method 800 may proceed to step 806. Where, at step 804, the channel selection criteria is not satisfied, the method 800 may proceed to step 808.

At step 806, the first device may select a first channel. In some embodiments, the first device may select the first channel in which to establish or maintain the sidelink session, based on the condition(s) of the channel satisfying the channel selection criteria. For example, the first device may select the first channel or sub-channel, responsive to the SINR of the first channel or sub-channel being greater than (or equal to) the threshold SINR. As another example, the first device may select the first channel or sub-channel, responsive to the first channel not being occupied. As yet another example, the first device may select the first channel or sub-channel, responsive to the RSSI being greater than (or equal to) the threshold RSSI.

At step 808, the first device may select a second channel. In some embodiments, where method 800 is performed as part of establishing a sidelink session, the first device may select (e.g., and sense conditions of) a second channel, as part of establishing the sidelink session. For example, the first device may repeat steps 802-804 for a different channel or sub-channel, until the channel selection criteria is satisfied.

In some embodiments, where the method 800 is performed as part of a full-duplex sensing and communication arrangement (e.g., as part of an ongoing sidelink session), the first device may hop to the different channel in which the conditions are sensed at step 802. For example, assuming the device is transmitting traffic (e.g., at step 706) on a first channel or sub-channel and the device is sensing channel conditions (e.g., at step 802) of a second channel or sub-channel, and the conditions of the second sub-channel are better channel conditions than that of the first channel, the device may switch to the second channel. Continuing this example, the device may transmit traffic to the second device on the first channel via one RF chain, and can sense the conditions on the second channel via a second RF chain, during one round of the sidelink session. The device may compare the sensed conditions of the second channel to the channel selection criteria. Assuming that the sensed conditions of the second channel satisfy the channel selection criteria, at step 808, the device may select the second channel for a second round of the sidelink session. In this regard, the first device may switch from the first channel to the second channel for a second round of the sidelink session, according to the sensed conditions.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit and/or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein may be embodied in other specific forms without departing from the characteristics thereof. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” can be construed as inclusive so that any terms described using “or” can indicate any of a single, more than one, and all of the described terms. A reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. The orientation of various elements may differ according to other exemplary embodiments, and that such variations are intended to be encompassed by the present disclosure.

What is claimed is:

1. A method, comprising:
establishing, by a first wireless communication device, a sidelink (SL) session with a second wireless communication device;
reserving, by the first wireless communication device, a block of SL slots for transmission of traffic between the first wireless communication device and the second wireless communication device; and
transmitting, by the first wireless communication device to the second wireless communication device, the traffic of the SL session in the block of SL slots.

2. The method of claim 1, wherein the first wireless communication device comprises a companion device and the second wireless communication device comprises a wearable device, and wherein the traffic comprises extended reality traffic.

3. The method of claim 1, wherein the block of SL slots comprises a plurality of consecutive time slots for the SL session.

4. The method of claim 1, further comprising:
switching, by the first wireless communication device, from an active mode to a sleep mode, after an end of a terminal time slot of the block of SL slots.

5. The method of claim 4, wherein the first wireless communication device remains in the sleep mode for a duration corresponding to a scheduling periodicity of the SL session.

6. The method of claim 1, wherein the SL session is established on a first sub-channel, the method further comprising, while transmitting the traffic to the second wireless communication device:
sensing, by the first wireless communication device, one or more conditions of a second sub-channel.

7. The method of claim 6, wherein the first wireless communication device comprises a first radio frequency (RF) chain and a second RF chain, wherein the traffic is transmitted to the second wireless communication device via the first RF chain, and wherein the one or more conditions are sensed via the second RF chain.

8. The method of claim 6, wherein transmitting the traffic of the SL session in the block of SL slots is for a first round of the SL session, the method further comprising:
switching, by the first wireless communication device, from the first sub-channel to the second sub-channel for a second round of the SL session, according to the one or more conditions.

9. A first wireless communication device, comprising:
a transceiver; and
one or more processors configured to:
establish a sidelink (SL) session with a second wireless communication device;
reserve a block of SL slots for transmission of traffic between the first wireless communication device and the second wireless communication device; and
transmit, via the transceiver, to the second wireless communication device, the traffic of the SL session in the block of SL slots.

10. The first wireless communication device of claim 9, wherein the first wireless communication device comprises a companion device and the second wireless communication device comprises a wearable device, and wherein the traffic comprises extended reality traffic.

11. The first wireless communication device of claim 9, wherein the block of SL slots comprises a plurality of consecutive time slots for the SL session.

12. The first wireless communication device of claim 9, wherein the one or more processors are further configured to:
switch, from an active mode to a sleep mode, after an end of a terminal time slot of the block of SL slots.

13. The first wireless communication device of claim 12, wherein the first wireless communication device remains in the sleep mode for a duration corresponding to a scheduling periodicity of the SL session.

14. The first wireless communication device of claim 9, wherein the SL session is established on a first sub-channel, and wherein the transceiver is configured to:
while transmitting the traffic to the second wireless communication device, sense one or more conditions of a second sub-channel.

15. The first wireless communication device of claim 14, wherein the transceiver comprises a full duplex transceiver comprising a first radio frequency (RF) chain and a second RF chain, wherein the traffic is transmitted to the second wireless communication device via the first RF chain, and wherein the one or more conditions are sensed via the second RF chain.

16. The first wireless communication device of claim 14, wherein transmitting the traffic of the SL session in the block of SL slots is for a first round of the SL session, and wherein the one or more processors are further configured to:
switch, via the transceiver, from the first sub-channel to the second sub-channel for a second round of the SL session, according to the one or more conditions.

17. A first wireless communication device, comprising:
a transceiver; and
one or more processors configured to:
establish a sidelink (SL) session with a second wireless communication device;
determine a reserved block of SL slots for transmission of traffic between the first wireless communication device and the second wireless communication device; and
receive, via the transceiver, from the second wireless communication device, the traffic of the SL session in the block of SL slots.

18. The first wireless communication device of claim 17, wherein the first wireless communication device comprises a wearable device and the second wireless communication device comprises a companion device, and wherein the traffic comprises extended reality traffic.

19. The first wireless communication device of claim 17, wherein the block of SL slots comprises a plurality of consecutive time slots for the SL session.

20. The first wireless communication device of claim 17, wherein the one or more processors are further configured to:
switch, from an active mode to a sleep mode, after an end of a terminal time slot of the block of SL slots,
wherein the first wireless communication device remains in the sleep mode for a duration corresponding to a scheduling periodicity of the SL session.
